(19) United States
(12) Patent Application Publication
(10) Pub. No.: US 2022/0072726 A1
(43) Pub. Date: Mar. 10, 2022

(54) PRESSING UNIT FOR A PORTIONING MACHINE

(71) Applicant: POLY-CLIP SYSTEM GMBH & CO. KG, Hattersheim (DE)

(72) Inventor: Martin BERGMANN, Hösbach (DE)

(21) Appl. No.: 17/416,438

(22) PCT Filed: Dec. 18, 2019
(86) PCT No.: PCT/EP2019/086044

§ 371 Date: Jun. 18, 2021

(30) Foreign Application Priority Data
Dec. 19, 2018 (DE) 102018132882.6

(51) Int. Cl. B26D 1/147; B26D 1/29; B26D 7/06

(52) U.S. Cl. CPC B26D 1/147; B26D 1/29; B26D 2210/04; B26D 7/0683; B26D 7/0641

(57) ABSTRACT

The present invention relates to a portioning machine for dividing a strand-like product into individual portions and a method of controlling such portioning machine. The portioning machine includes a magazine turret attachment for receiving the strand-like product, a pressing unit for pressure-compacting the strand-like product at least in its longitudinal direction, and a portioning and cutting device for portioning and separating individual portions from the strand-like product. The magazine turret attachment has a base segment and a turret segment which have chute portions oriented coaxially with respect to one another for forming at least one reception chute for the strand-like product and which are rotatable about a common axis for positioning the reception chute in a cutting position; and wherein the pressing unit for pressure-compacting the strand-like product has at least one pressure ram and a counter-pressure element. The counter-pressure element is a slide element arranged between the base segment and the turret segment of the magazine turret attachment and is reversibly movable in a direction at least approximately perpendicular to the axis of rotation of the magazine turret attachment between a release position and a closure position for unblocking or closing the reception chute placed in the cutting position.

### FIELD OF THE INVENTION

The present invention relates to a portioning machine for dividing a strand-like product into individual portions.

BACKGROUND

Portioning machines are used, for example, to cut strand-like products such as meat products, in meat strands, as well as fish, poultry or sausage products, or bakery products into slices which are subsequently packaged as individual portions or packaged into portions containing several slices. In particular, when meat strands are cut into slices it is often desirable for the cut slices to be of equal thickness, equal weight and uniform shape. In order to achieve this, the meat strand that needs to be cut is pressed into the desired shape in order to achieve a homogeneous consistency along its length.

European Patent Application 2 532 493 discloses a portioning machine which serves for cutting weight-accurate portions from a strand-like cutting material and which has a form tube turret containing several form tubes for receiving the cutting material. The form tube turret consists of several disc-shaped elements. Between two disc-shaped elements, a further disc element is arranged against which a ram pressure-compacts the cutting material. This disc element has a separate drive mechanism and is rotatable about the axis of the form tube turret.

A further portioning device for dividing a chunk of foodstuff into portions having a predefined weight or a predefined thickness is known from EP-Patent 1 445 078. This device includes, among other things, a horizontally oriented drum having laterally open insertion chambers provided therein for receiving the chunk of foodstuff that is to be divided. For pressure-compacting the chunk of foodstuff in a transverse direction, a pressure ram is laterally inserted into the insertion chamber. In a longitudinal direction, the chunk of foodstuff is pressed into portioning chambers provided at a front end of the drum and a portion corresponding to the size of the portioning chamber is cut off from the chunk of foodstuff.

Using these portioning machines, it is possible to pressure-compact a strand-like product such as a meat strand at least in its longitudinal direction prior to dividing it into individual portions. However, the devices for pressure-compacting the strand-like product as proposed in these documents have a complicated structure and therefore require a corresponding, high degree of control expenditure. A further drawback consists in the fact that when a portioning chamber is used, it must be emptied before it can be re-used, which sets an additional limit to the achievable production speed.

It is therefore an object of the present invention to propose a portioning machine for dividing a strand-like product into individual portions which has a simpler structure and thus requires a lower degree of control expenditure while continuing nonetheless to be usable in a flexible manner.

### SUMMARY OF THE INVENTION

According to the invention, a portioning machine for dividing a strand-like product into individual portions is proposed. The portioning machine includes a magazine turret attachment for receiving the strand-like product, a pressing unit for pressure-compacting the strand-like product at least in its longitudinal direction, and a portioning and cutting device for portioning and separating individual portions from the strand-like product. The magazine turret attachment has a base segment and a turret segment which have chute portions oriented coaxially with respect to one another for forming at least one reception chute for the strand-like product and which are rotatable about a common axis for positioning the reception chute in a cutting position. The pressing unit for pressure-compacting the strand-like product has at least one pressure ram and a counter-pressure element. The counter-pressure element is a slide element arranged between the base segment and the turret segment of the magazine turret attachment which is reversibly movable in a direction at least approximately perpendicular to the axis of rotation of the magazine turret attachment between a release position and a closure position for unblocking or closing the reception chute placed in the cutting position.

The pressing unit, and in particular the slide element, may thus be activated independently of the rotary drive mechanism of the turret unit.

In the simplest use case, the base segment of the turret base has a clearance corresponding to the slide element into which the slide element may be reversibly slid.

In order to achieve pressure-compacting of the strand-like product at least in a longitudinal direction preferably directly before the portioning operation, it is advantageous for the pressure ram of the pressing unit to be aligned coaxially with the reception chute when the latter is in the cutting position. One single pressure ram or a plurality of pressure rams, stored in a magazine, may be provided for pressure-compacting the strand-like product and may be changed automatically via a driven changer and moved into a pressing position.

If the pressing unit comprises a preferably planar separating element arranged between the base segment and the turret segment of the turret base which is arranged in a stationary manner with respect to a frame element of the portioning machine, this may, in addition, prevent the strand-like product from slipping through the turret unit when it is being filled into the turret unit. The separating element may be realised as a simple metal sheet, since it is not driven and serves merely for preventing the strand-like product from slipping through the chute.

It is further of advantage if the separating element has a clearance in the zone of the cutting position which is engaged by the slide element when the latter is in its closure position. Thus it is possible for the strand-like product, when it is in its cutting position, to be both pressure-compacted in its longitudinal direction and cut into individual portions. There is thus no need for driving the turret unit between the pressing operation and the cutting operation.

The clearance in the separating element may have any particular suitable shape, such as an oval or a polygon. It must simply be ensured that the reception chute for the strand-like product is kept unblocked when the latter is in the cutting position. In an advantageous configuration, the separating element has an approximately rectangular clearance and the slide element has an approximately rectangular shape corresponding thereto. A rectangular shape, or a similar shape having at least parallel lateral edges, upon linear guiding of the slide element, ensures a reliable closure and a reliable unblocking of the reception chute when the latter is placed in the cutting position.

In order to ensure a more reliable guiding of the slide element, provision may be made in an advantageous configuration for the separating element to have guiding means for guiding the slide element during the reversible shifting movement for unblocking and closing the reception chute when it is in the cutting position. These may be guiding grooves in the separating element in which the slide element is guided.

In a further advantageous configuration, provision is made for the slide element to be connected to a linear drive for reversible movement between the release position and the closure position. A linear drive makes it possible to move the slide element along the shortest distance between the release position and the closure position, thus allowing to accelerate the portioning operation.

In a preferred embodiment of the portioning machine according to the invention, a transporting device for removing the individual portions that have been separated from the strand-like product may additionally be provided. The transporting device makes it possible to form individual portions and also groups of individual portions which may, for example, be transported to a packaging facility. According to a preferred embodiment, the transporting device may be formed by a transport belt.

For this purpose, the portioning machine according to the invention obviously has a control unit which may include, in addition to general control routines, specific control programmes permitting it, for example, to form predefined or freely selectable groups of individual portions by activating the transporting device correspondingly in a given manner.

The control unit may, for example, control the pressing operation in such a manner that only one pressing operation will be performed and that subsequently the compressed, strand-like product will be divided in its entirety into individual portions. However, it is also possible for the pressing operation to be controlled in such a manner that a new pressing operation will be performed after each separation of an individual portion from the strand-like product. There is thus a possibility, in this case, to make provisions for the slide element to be moved into the closure position after each separation of an individual portion from the strand-like product, in view of a renewed pressure-compacting operation of the strand-like product.

In an exemplary embodiment of the present invention, the slide element is formed all-over its surface and/or is made of solid material. For example, the slide element has a greater dimension in the sliding direction (length) than in a direction transverse to the sliding direction (width). Furthermore, provision may be made for the slide element to be devoid of any through holes for the strand-like product.

According to an exemplary further development, the slide element is dimensioned in such a manner, and/or is arranged in such a manner that, when it is in the closure position, the central axis or rotation axis of the magazine turret attachment does not intersect the slide element. The translatory movement of the slide element is set in such a manner that, when considered in the direction of the rotation axis A of the magazine turret attachment, the slide element covers at most 50%, at most 45%, at most 40%, at most 35% or at most 30% of the disc-shaped base segment.

In a further exemplary embodiment of the portioning machine according to the invention, the slide element is withdrawn from the magazine turret attachment when in the release position. For example, the slide element is completely withdrawn from the magazine turret attachment, such that the slide element does not overlap or cover the disc-shaped base segment when considered in the axis of rotation of the magazine turret attachment. In an alternative embodiment, the sliding member is not completely withdrawn from the magazine turret attachment when in the release position, with the sliding member overlapping or covering the base segment in its peripheral zone when considered in the direction of the rotation axis, provision being made, however, at the same time for the slide element to release the product so that it can be conveyed further through the magazine turret attachment.

In a further exemplary embodiment of the present invention, the slide element is arranged in such a manner when it is in the release position and/or the slide element is realised in such a manner that the compressed, strand-like product may pass by the slide element when the latter is in the release position. This is to say that, once the preliminary pressure-compacting has been accomplished, the compressed, strand-like product will move automatically, due to the effect of gravity, and/or by actuation of a pressure ram, in the direction of the portioning and cutting device, passing by the slide element. For example, the compressed, strand-like product passes by a front edge of the slide element which points in the direction of the rotation axis of the magazine turret attachment without contacting the slide element.

One advantage of the translatory displacement of the slide element, in particular over a rotatory movement thereof, is that this allows an increased production speed. This is related to the fact that due to the translatory movement of the slider element, the preliminarily pressure-compacted product may be conveyed further to a next stage at a considerably faster pace than would be possible in the case of a rotatory movement. The chute portions provided in the turret segments have a conventional, elongated shape and are arranged within the turret segments in such a manner that the long sides are essentially oriented in the circumferential direction of the discs of the turret segments. The short sides, which essentially interconnect opposing long sides with each other, are oriented essentially transversely thereto, in particular essentially in a radial direction with respect to the discs of the turret segments. Thus, the translatory slide element needs to release only the short sides when being moved to and fro between the release position and the closure position. This is to say that the movement amplitude is set depending on the short sides. This is to say that the movement amplitude of the translatory movement between the closure position and the release position is considerably smaller and, consequently, the actuating time, i. e. the time required to move the translatory slide element to and fro between the closure position and the release position, is considerably reduced.

Furthermore, according to the present invention, a method of controlling a portioning machine for dividing a preferably strand-like product into individual portions is proposed. The portioning machine includes a magazine turret attachment for receiving the strand-like product, a pressing unit for pressure-compacting the strand-like product at least in its longitudinal direction, and a portioning and cutting device for portioning and separating individual portions from the strand-like product.

The method includes the steps of:
inserting a strand-like product into at least one reception chute of the magazine turret attachment;
pressure-compacting the strand-like product at least in its longitudinal direction by displacing a pressure ram into the reception chute in the direction of a slide element of the pressing unit located in the closure position;
moving the slide element to a release position after the pressure-compacting operation has been accomplished;
displacing the pressure-compacted, strand-like product in the direction of the portioning and cutting device by means of the pressure ram of the pressing unit; and
separating individual portions from the pressure-compacted, strand-like product by the portioning and cutting device.

In accordance with the inventive method, the reception chute for inserting the strand-like product is placed in a reception position. In other words, a reception chute previously emptied at the cutting position is transferred to the reception position so that another strand-like product may be inserted therein.

In a subsequent step according to the inventive method, the reception chute is moved to a cutting position, once a strand-like product has been inserted therein.

According to the inventive method, the pressure-compacted, strand-like product is advanced portionwise by the pressure ram, once the pressure-compacting operation has been accomplished.

If the portioning machine has a transporting device for removing the individual portions separated from the strand-like product, the inventive method may include the additional step of controlledly driving said transporting device for creating individual portions or groups of individual portions.

By using the inventive method, all of the advantages explained in connection with the inventive portioning machine are realised.

Equally within the scope of the present invention and independently of the inventive embodiments explained further above, a magazine turret attachment to be used with a portioning machine for dividing a strand-like product into individual portions is proposed. The magazine turret attachment includes a turret base rotatable about an axis of rotation which has at least one chute extending through the turret base and the chute axis of which extends at least approximately parallel to the rotation axis of the turret base, and at least one first chute module which may be reversibly arranged on the turret base in the area of the first chute and which is provided with only one chute extending through said first chute module and the chute axis of which extends coaxially to the chute axis of the first chute of the turret base and the cross-section of which corresponds at least approximately to the cross-section of the at least one chute of the turret base in order to form a first reception chute for a strand-like product.

A configuration of this type makes it possible to provide a very compact chute module for forming a single reception chute for the strand-like product which may be handled easily and flexibly.

According to a preferred configuration, the turret base has at least one second chute extending through the turret base and the chute axis of which extends at least approximately parallel to the axis of rotation of the turret base. It is thus possible to form a further reception chute for the strand-like product on the turret base.

In a further preferred configuration, provision is made for a first chute module for forming a second reception chute for the strand-like product to be reversibly arrangeable on the turret base in the area of the second chute. It is thus possible to form two identical reception chutes for the strand-like product on the turret base.

Furthermore, it is advantageous if several first and second chutes are arranged in the turret base. Furthermore, provision may be made for the first and second chutes to be realised as pairs having identical cross-sections. Providing several identical chutes, such as providing pairs of identical chutes, makes it possible to simultaneously portion a strand-like product placed in one chute, while refilling the identical, empty chute at the same time.

If in the area of the first chute the turret base, on its side which faces towards the first chute module when the first chute module is arranged on the turret base, has at least one connecting portion, and if the at least one first chute module, on its side which faces towards the turret base when the first chute module is arranged on the turret base, has at least one counter-connecting portion, the first connecting portion and the first counter-connecting portion of the first chute module may enable a positive connection and/or a nonpositive connection of the chute module with the turret base for forming a reception chute for the essentially strand-like product.

In order to create a positive connection and/or a nonpositive connection, the first connecting portion of the turret base and the counter-connecting portion of the first chute module may be formed by complementary geometries.

In an advantageous configuration, the first connecting portion of the turret base is a recess extending circumferentially about the first chute of the turret base, whereas the first counter-connecting portion of the first chute module is a projection corresponding to the recess formed in the turret base and extending circumferentially about the chute of the first chute module.

It is further advantageous if the first chute module, on its side facing away from the turret base when the first chute module is arranged on the turret base, has at least one second connecting portion. The reception chute for the strand-like product may thus be adjustable in its length by superposing several first chute modules.

Obviously, the connecting portions may also be configured in another manner. One connecting portion may, for example, be formed by a drill hole which may be engaged by a matching bolt which forms the corresponding connecting portion.

If the first connecting portion of the turret base and the second connecting portion of the first chute module are identically configured, the first chute modules may be placed above one another and above the turret base in any given order.

The chute modules provided for forming a reception chute may be of equal length. However, chute modules of different lengths may also be provided, thus enabling an even more precise length adjustment of the reception chute.

In a further preferred embodiment of the magazine turret attachment according to the invention, a second chute module is provided which may be reversibly arranged on the first chute module or on the turret base and which has a chute extending through the second chute module the chute axis of which extends coaxially to the chute axis of the first chute module and/or to the axes of the first or second chutes of the turret base and the cross-section of which at least approximately corresponds to the cross-section of the chute of the first chute module, the second chute module having a locking recess formed on its side facing away from the first chute module when the second chute module is arranged on the first chute module. A locking recess of this type makes it possible to fasten the reception chute for the strand-like product formed by the chute module on a suitable mount in order to stabilise the chute module in its position. A suitable mount may, for example, be formed by a shaft or similar object extending parallel to the chute module.

In an advantageous configuration, an essentially rod-shaped locking element is provided which has connecting portions formed on its ends and corresponding to the locking recesses of the second chute modules. It is thus possible, if two or more reception chutes are formed, to interconnect these by means of one or several locking elements.

According to the invention, provision may further be made for the turret base to have a base segment and a turret segment which are interconnected in such a manner that they may concurrently be rotatorily driven about their common central axis.

Further advantageously, provision may be made, in case the turret base is formed in two parts, for an essentially planar separating unit to be arranged between the base segment and the turret segment of the turret base. This makes it possible for a strand-like product inserted into the reception chute of the chute module of the magazine turret attachment to be positioned with precision.

The separating unit may be configured in various manners. However, it is advantageous if the essentially planar separating unit is an at least approximately circular metal sheet provided with at least one clearance arranged in the area of a chute portion of the turret base. A separating unit formed in this manner makes it possible to safely insert a strand-like product into a reception chute placed in a filling position and to transfer the strand-like product to a corresponding cutting device which is arranged in the area of a reception chute when the latter is located in the cutting position.

The turret base may be a two-part configuration consisting of a base segment and turret segment connected thereto, which makes it possible to arrange a separating unit between these segments.

However, if such a separating unit within the magazine turret attachment is not required, it is obviously possible for the base segment and the turret segment of the turret base to be integrally formed as one single component.

Furthermore, according to the present invention and independently of the inventive embodiments explained further above, a portioning machine for dividing a preferably strand-like product into individual portions is proposed which comprises a magazine turret attachment according to the present invention and a cutting device arranged in the area of turret base for separating an individual portion from the strand-like product prepared and held ready within the magazine turret attachment.

The portioning machine according to the invention offers all of the advantages explained in connection with the inventive magazine turret attachment.

### DESCRIPTION OF THE DRAWINGS

Example embodiments of the portioning machine according to the invention and of the equally inventive method will now be explained in connection with the following figures in the set of drawings. The terms “above”, “below”, “right”, “left” refer to the corresponding orientation as illustrated in the respective figure in the set of drawings.

In the drawings:

FIG. 1 is a portioning machine according to the present invention;

FIG. 2 is an example embodiment of a slide element according to the invention;

FIG. 3 is an example embodiment of a magazine turret attachment according to the invention; and

FIG. 4 is a further example embodiment of a magazine turret attachment according to the invention.

### DETAILED DESCRIPTION

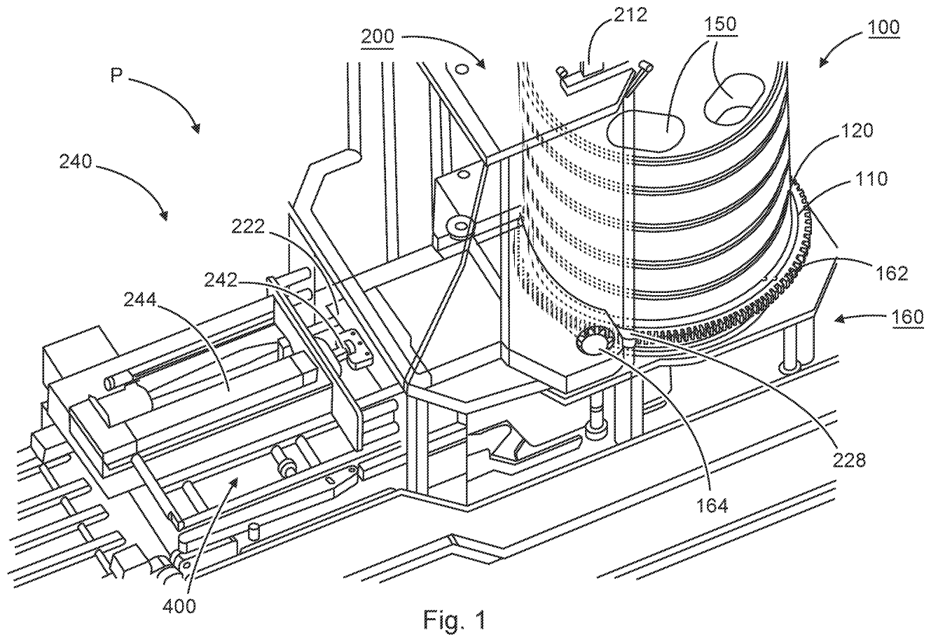

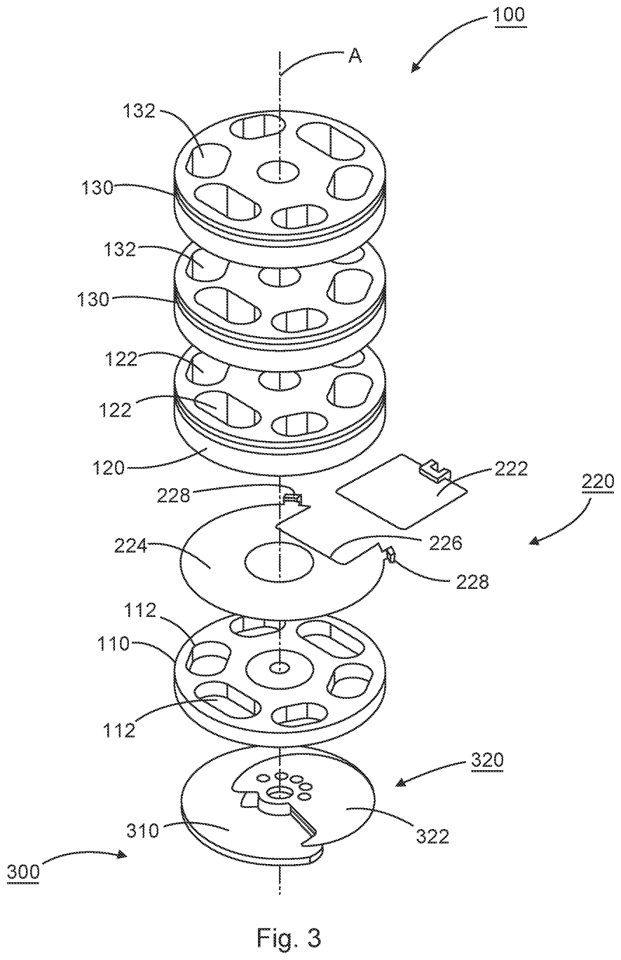

A portioning machine P according to the present invention and as shown in FIG. 1 includes a magazine turret attachment 100 for receiving a strand-like product, a pressing unit 200 for pressure-compacting the strand-like product, and a portioning and cutting device 300 for portioning and separating individual portions from the strand-like product (cf. FIG. 3), as well as a transporting apparatus 400 for removing the individual portions or groups of individual portions.

The magazine turret attachment 100 comprises a turret base having a central axis A, a disc-shaped base segment 110, and an equally disc-shaped turret segment 120 which are oriented coaxially with respect to each other.

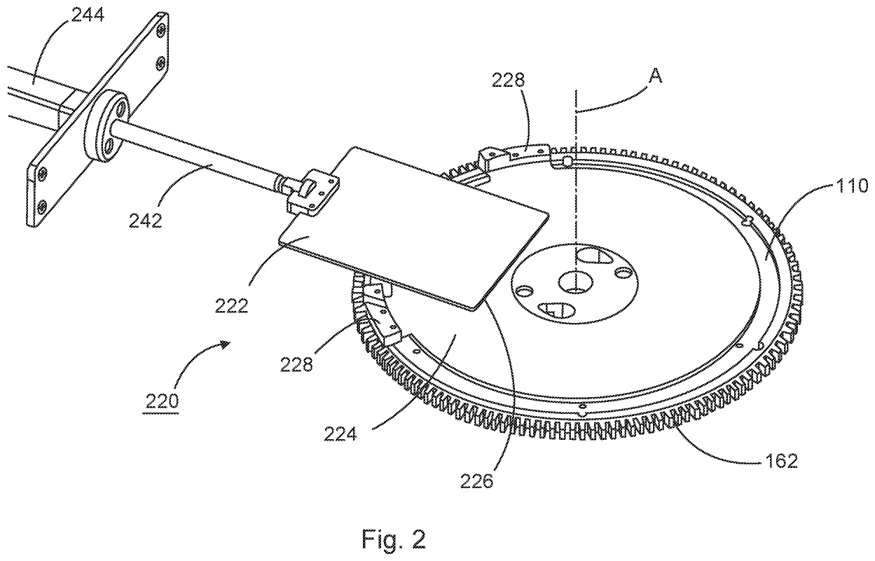

The base segment 110 has chute portions 112 which extend through the base segment 110 and are oriented parallel to the central axis A of the magazine turret attachment 100 (cf. FIGS. 2, 3). The chute portions 112 have an at least partially oval cross-section which is adapted to the strand-like product. According to the embodiment of FIG. 3, six chute portions 112 are arranged in the base segment 110 along the circumference in such a manner that every two chute portions 112 form a respective pair and are arranged opposite to each other with respect to a central axis A of the magazine turret attachment 100. The pairs of chute portions 112 located opposite to each other have identical cross-sections. This is to say that the chute portions 112 have identical pairs of cross-sections; however, the cross-sections of the individual pairs of chute portions 112 may differ from one another, such that, all in all, two or more, in particular three, pairs of chute portions 112 having different cross-sections may be provided. Obviously, it is also possible that all chute portions 112 of the base segment 110 have identical cross-sections.

The turret segment 120 has equally chute portions 122 which extend through the turret segment 120 and are oriented parallel to the central axis A of the turret base. As can be seen in FIG. 2, the disposition and the cross-section of the chute portions 122 in the turret segment 120 correspond to the disposition and the cross-section of the chute portions 112 in the base segment 110.

The base segment 110 and the turret segment 120 are oriented in such a manner towards each other that chute portions 112, 122 with identical cross-sections are aligned congruently above one another, thus forming continuous chute portions within the turret base.

The magazine turret attachment 100 may be driven o as to rotate about its central axis A. For this purpose, a drive mechanism 160 is provided which comprises a first drive element 162 in the form of a gear rim extending circumferentially about the base segment and a second drive element 164 in the form of a pinion which engages the gear rim 162 and may be driven by a corresponding non-illustrated motor.

The magazine turret attachment 100 corresponding to the example embodiment of FIG. 3 comprises further disc-shaped turret segments 130 for forming reception chutes 150. The turret segments 130 may have a structure identical to that of the turret segment 120. In order to form one or more reception chutes 150 having a desired length, the turret segments 130 may differ in their axial length from that of the turret segments 120. In addition, turret segment 130 having various different axial lengths may be provided in order to achieve a more precise adjustment of the length of the reception chutes 150. Each of the turret segments 130 is adapted to form all reception chutes 150 of the magazine turret attachment 100 at the same time.

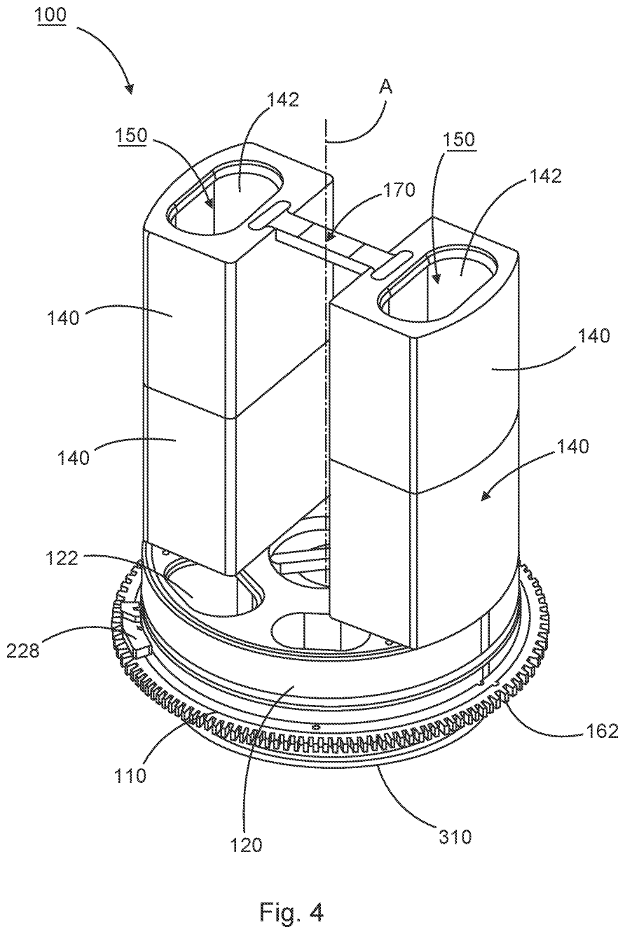

In an alternative configuration of the inventive magazine turret attachment 100 according to FIG. 4, chute modules 140 are provided to form the reception chutes 150. The chute modules 140 may be used to form one single reception chute 150 or, as can be seen in FIG. 4, several reception chutes 150 such as, for example, a pair of reception chutes 150 arranged opposite each other with respect to the central line A.

The pressing unit 200 comprises a pressure ram which is arranged above the magazine turret attachment and of which only the mount 212 is shown in FIG. 1. The pressure ram has a replaceable ram element the cross-section of which corresponds to the cross-section of the reception chute 150 into which the latter is to be inserted. It is to be understood that for adapting the pressure ram to a specific cross-section of the reception chute 150, a corresponding ram element is attached to the pressure ram. Alternatively, the entire pressure ram might be conceived to be exchangeable.

The pressing unit 200 further comprises a counter-pressure device 220 having a counter-pressure element 222 which is realised in the form of a slide element. The counter-pressure element or slide element 222 is horizontally oriented and arranged in such a manner that it may be slid reversibly between the base segment 110 and the turret segment 120 of the magazine turret attachment 100. For this purpose, a linear drive 240 is provided which is realised, according to the configuration of FIGS. 1 and 2, as a piston-cylinder arrangement having a piston 242 on the free end of which the slide element 222 is fastened and a cylinder 244. The slide element 222 has an essentially rectangular shape and may consist of, for example, stainless steel or of some other type of material suitable for contact with foodstuffs. Furthermore, the slide element 222 may have a coating that protects the material and/or conveys suitability for contact with foodstuffs to the slide element 222.

As can further be seen from FIG. 1, the counter-pressure device 220 is arranged on the portioning machine 1 in such a manner that, when placed between the base segment 110 and the turret segment 120, the slide element 222 closes the reception chute 150, above which the pressure ram 210 is placed and into which it plunges in order to pressure-compact the strand-like product. This reception chute 150 is in a cutting position, as will be explained in detail further below.

The counter-pressure device 220 further comprises a separating element 224 in the form of a metal sheet. The separating element 224 is configured as an approximately circular, planar element the diameter of which is slightly smaller that the diameter of the base segment 110 or of the turret segment 120 of the turret base, such that the reception chutes are interrupted between the chute portions 112, 122 of the base segment 110 and those of the turret segment 120. The separating element 224 has a clearance 226 formed in the area of the cutting position, such that in this position, a continuous chute for the strand-like product will be remain intact.

The clearance 226 in the separating element 224 has a size which is selected such that even the reception chute 150 having the largest cross-section will remain intact in the area of the cutting position.

Furthermore, the shape of the clearance 226 essentially corresponds to the shape of the slide element 220. As can be seen from FIGS. 2 to 3, the clearance 226 may be at least approximately rectangular and the slide element 222 has a portion having a rectangular shape corresponding thereto, so as to close the clearance 226 in the separating element 224 allover, at least in the area of the turret base. It is thus possible to prevent parts of the strand-like product to be processed from getting into the space formed between the separating element 224 and the lower base segment 110 of the turret base.

As exemplarily represented in FIG. 2, the slide element 220 is formed as a full-surface component and/or made of solid material. Furthermore, in the exemplary embodiment, the slide element 220 has a greater dimension in the sliding direction (length) than in a direction transverse to the sliding direction (width). The slide element 220 is devoid of any through holes for the strand-like product.

Furthermore, as can be seen from FIG. 2, the slide element 220 does not intersect the central axis or rotation axis A of the magazine turret attachment 100 when it is in the closure position. In other words, the translatory movement of the slide element 220 is set in such a manner that, when considered in the direction of the rotation axis A of the magazine turret attachment 100, the slide element 220 covers at most 50%, at most 45%, at most 40%, at most 35% or at most 30% of the disc-shaped base segment 110.

In a further exemplary embodiment of the portioning machine according to the invention, the slide element 220 is withdrawn from the magazine turret attachment when in the release position. For example, the slide element is completely withdrawn from the magazine turret attachment, such that the slide element does not overlap or cover the disc-shaped base segment when considered in the axis of rotation of the magazine turret attachment. In an alternative embodiment, the sliding member is not completely withdrawn from the magazine turret attachment when in the release position, with the sliding member overlapping or covering the base segment in its peripheral zone when considered in the direction of the rotation axis, provision being made, however, at the same time for the slide element to release the product so that it can be conveyed further through the magazine turret attachment.

Two engaging elements 228 are provided on the separating element 224 in order to ensure that the separating element 224 with its clearance 226 is secured in the cutting position while the magazine turret attachment 100 is rotated about the central axis A in order to move a reception chute 150, together with a strand-like product received therein, from the filling position to the cutting position. The engaging elements 228 are in engagement with a stationary frame element of the portioning machine.

The exploded view according to FIG. 3, which represents the release position of the slide element 220, shows that the compressed, strand-like product P may move beyond the slide element 220 in the direction of the base segment 210. This is to say that, once the preliminary pressure-compacting has been accomplished, the compressed, strand-like product P will move automatically, due to the effect of gravity, and/or by actuation of a (non-illustrated) pressure ram, in the direction of the portioning and cutting device 300, passing by the slide element 200. For example, the compressed, strand-like product P passes by a front edge of the slide element 200 which points in the direction of the rotation axis A of the magazine turret attachment 100 without contacting the slide element 200.

In order to cut a strand-like product into portions or slices of preferably equal thickness or equal weight, a portioning and cutting device 300 is arranged below the magazine turret attachment 100.

The portioning and cutting device 300 comprises a portioning disc 310 which is arranged below the base segment 110 and is parallel thereto. The distance between the top of the portioning disc 310 and the bottom of the base segment 110 corresponds to the desired thickness of the individual portion and may be set by shifting the portioning disc 310 along the central axis A. In the area of the cutting position, the portioning disc 310 has an opening through which the individual portion which has been separated from the strand-like product may be evacuated downwards, for example, in order to be placed onto, and carried away by, the transporting device 400 arranged below the portioning and cutting device 300.

The portioning and cutting device 300 further comprises a cutting device 320 including a cutter blade 322. The cutter blade 322 is configured as a rotary blade and is arranged at the bottom of the base segment 110 in such a manner that it may be rotatorily driven about the central axis A. The cutter blade 322, upon a rotation of 360° about the central axis A, separates a portion of the strand-like product protruding from the lower end of the reception chute 150 and extending down to the portioning disc 310 from the remaining strand.

In order to cut a strand-like product into portions or slices of preferably equal thickness or equal weight, first the distance between the portioning disc 310 and the base segment 110 is set so as to correspond to the desired thickness of the slice.

Depending on the length of the strand-like product to be cut, one or several turret segments 130 are placed onto the turret segment 120 of the turret base in order to form the reception chutes 150. For aligning and securing the turret segments 130 with respect to one another and to the turret segment 120 of the turret base, connecting and securing elements may be provided. Such connecting and securing elements may be realised as bolts which extend parallel to the central axis A through all turret segments 120, 130, bracing them against each other. Alternately, separate connecting and securing elements may be provided on each turret segment 120, 130.

In an alternative embodiment of the magazine turret attachment 100, according to FIG. 4, one single chute module 140 or a given number of chute modules 140 are connected to the turret segment 120 and are interconnected with the other chute modules 140 by means of connecting portions in order to form the reception chute 150. In this embodiment, the reception chutes 150 may be stabilised by attaching a locking element 170 onto the top ends of the reception chutes 150.

First, the strand-like product to be cut is inserted into the reception chute 150 which is located in a filling position. The filling position is the position of a reception chute 150 when it is located opposite the counter-pressure device 220. In the portioning machine according to FIG. 1, the filling position is located on its right-hand side.

Then, the magazine turret attachment 100 is rotated by 180° about the central axis A, such that the filled reception chute 150 faces towards the counter-pressure device 220, when considered from the central axis A. It thus is located in the cutting position.

Before the filled reception chute 150 is transferred from the filling position to the cutting position, the slide element 222 of the counter-pressure device 220 is moved into the closure position, illustrated in FIG. 2, in which the reception chute 150 is interrupted between the chute portions 112, 122 of the base segment 110 and of the turret segment 120 by the slide element 222.

When the filled reception chute 150 is located in the cutting position, the pressure ram is inserted into the reception chute 150, with the strand-like product being pressed against the slide element 222 by the pressure ram and therefore desirably compressed.

As soon as the desired degree of compression of the strand-like product has been reached, that is, if the strand-like product has assumed, for example, a desired cross-section corresponding, for example, to the cross-section of the reception chute 150, the slide element 222 is withdrawn from the turret unit 100 in a radial direction by the linear drive 240 and thus transferred to the release position (cf. FIG. 3). Thereby, the reception chute 150 between the chute portions 112, 122 of the base segment 110 and of the turret segment 120 are unblocked.

The compressed, strand-like product may now be moved, either automatically by gravitational force or by corresponding actuation of the pressure ram, in the direction of the portioning and cutting device 300 until the lower end of the strand-like product is applied against the portioning disc 310. Subsequently, by actuating the cutter blade 322, an individual portion in the form of a slice is separated from the strand-like product and, due to the clearance in the portioning disc 310, may fall onto the transporting device 400 arranged thereunder.

Subsequently, the strand-like product may be further advanced in the direction of the portioning and cutting device 300 by gravitational force or gradual advancement of the pressure ram.

The transporting device 400 may be configured, for example, as a transport belt and may be activated by the control unit of the portioning machine P in such a manner that each individual portion or slice is carried away as a separate portion or in such a manner that several individual portions or slices are deposited on top of one another or in a fanned-out disposition in order to be carried away and packaged as overall portions.

While the strand-like product present in the reception chute 150 located in the cutting position is being compressed and cut into individual portions, a further strand-like product may simultaneously be inserted into the opposite reception chute 150 which is located in the filling position, in order to be subsequently transferred into the cutting position where it may then be processed as described above.

If immediately after the currently processed strand-like product a different type of strand-like product needs to be processed, it is possible, when a magazine turret attachment 100 according to FIG. 3 is employed, to fill one of the other reception chutes, for example those provided to the right or to the left of the reception chute 150 currently placed in the filling position. It is basically possible to proceed in this manner since the separating element 224 of the counter-pressure device 220 closes all reception chutes 150 of the magazine turret attachment 100 with the exception of the reception chute 150 that is placed in the cutting position.

Two different example embodiments of a magazine turret attachment 100 according to the invention have been described in FIGS. 3 and 4. Referring to the embodiment of the magazine turret attachment 100 according to FIG. 3, it is to be noted that the drive element 162 at the base segment 110 of the turret base is not illustrated, that such a drive element, however, basically needs to be present if the turret unit 100 is supposed to be rotatorily drivable about its central axis A.

It is further to be noted, concerning the example embodiments of FIGS. 3 and 4, that these basically differ from each other in that the reception chutes 150 above the turret base are formed by turret segments 130 (FIG. 3) or by chute modules 140 (FIG. 4). When turret segments 130 are used, all reception chutes 150 are formed simultaneously, whereas when chute modules 140 are used, this will create only one reception chute 150. It is further to be noted that the turret base of the embodiments of the turret unit 100 according to FIGS. 3 and 4 are essentially identical, such that it is possible, when the same turret base is used, to alternately use either the turret segments 130 or the chute modules 140 in order to form the reception chutes 150.

As can be seen in FIGS. 2 and 3, the slide element 222, on its side facing in the direction of the magazine turret attachment 100, is provided with a portion the shape of which corresponds to the shape of the clearance 226 formed in the separating element 224 in order to fill said clearance all-over when in the closure position. The part of the slide element 222 protruding from the magazine turret attachment 100, on the other hand, may be of any particular shape. The only important thing about this part of the slide element 222 is that it must be suitable for connecting to the piston 242 of the linear drive 240.

The slide element 222 is reversibly moved, according to the example embodiments of FIGS. 1 to 4, from the closure position to the release position by means of a linear drive. It is also possible to use other suitable drive mechanisms for this movement. The linear drive 240 explained in connection with the counter-pressure device 220 may also be realised by a type of drive mechanism other than the illustrated piston and cylinder drive. Such a drive mechanism may, for example, comprise a gear rack or a threaded spindle allowing to cause a linear movement of the slide element 222. In addition, the drive mechanism of the slide element 222 may be a pneumatic, hydraulic or electric drive.

### REFERENCE SIGNS:

A central axis P portioning machine 100 magazine turret attachment 110 base segment 112 chute portions 120 turret segment 122 chute portions 130 turret segments 140 chute modules 150 reception chutes 160 drive mechanism 162 gear rim 164 pinion 170 locking element 200 pressing unit 210 pressure ram 212 mount 220 counter-pressure device 222 slide element 224 separating element 226 clearance 228 engaging elements 240 linear drive 242 piston 144 cylinder 300 portioning and cutting device 310 portioning disc 320 cutting device 322 cutter blade 400 transporting apparatus

1. A portioning machine [[(P)]] for dividing a strand-like product into individual portions, the portioning machine [[(P)]] including:
a magazine turret attachment [[(100)]] for receiving the strand-like product, a pressing unit [[(200)]] for pressure-compacting the strand-like product at least in its longitudinal direction, and a portioning and cutting device [[(300)]] for portioning and separating individual portions from the strand-like product;
wherein the magazine turret attachment [[(100)]] has a base segment [[(110)]] and a turret segment [[(120)]] which have chute portions [[(112, 122)]] oriented coaxially with respect to one another for forming at least one reception chute (150) for the strand-like product and which are rotatable about a common axis [[(A)]] for positioning the reception chute [[(150)]] in a cutting position; and wherein the pressing unit [[(200)]] for pressure-compacting the strand-like product has at least one pressure ram and a counter-pressure element [[(222)]];
wherein the counter-pressure element [[(222)]] is a slide element [[(222)]] arranged between the base segment [[(110)]] and the turret segment [[(120)]] of the magazine turret attachment [[(100)]] and is reversibly movable in a direction at least approximately perpendicular to the axis of rotation [[(A)]] of the magazine turret attachment [[(100)]] between a release position and a closure position for unblocking or closing the reception chute [[(150)]] placed in the cutting position.

2. The portioning machine as claimed in claim 1, wherein the pressure ram of the pressing unit [[(200)]] is aligned coaxially with respect to the reception chute [[(150)]] when in the cutting position.

3. The portioning machine as claimed in claim 1 or 2, wherein the pressing unit [[(200)]] comprises a preferably planar separating element [[(224)]] arranged between the base segment [[(110)]] and the turret segment [[(120)]] of the magazine turret attachment [[(100)]] which is arranged in a stationary manner with respect to a frame element of the portioning machine [[(1)]].

4. The portioning machine as claimed in claim 3, wherein the separating element [[(224)]] has a clearance [[(226)]] in the zone of the cutting position which is engaged by the slide element [[(222)]] when the latter is in its closure position.

5. The portioning machine as claimed in claim 4, wherein the separating element [[(224)]] has an approximately rectangular clearance [[(226)]] and the slide element [[(222)]] has an approximately rectangular shape corresponding thereto.

6. The portioning machine as claimed in any one of claims 1 to 5 claim 3 wherein the separating element [[(224)]] has guiding means for guiding the slide element [[(222)]] during the reversible shifting movement for unblocking and closing the reception chute [[(150)]] when it is in the cutting position.

7. The portioning machine as claimed in any one of claims 1 to 6 claim 1, wherein the slide element [[(222)]] is connected to a linear drive [[(240)]] for reversible movement between the release position and the closure position.

8. The portioning machine as claimed in any one of claims 1 to 7 claim 1 wherein a transporting device [[(400)]] is provided for removing the individual portions that have been separated from the strand-like product.

9. The portioning machine as claimed in any one of claims 1 to 8 claim 1, wherein the slide element [[(222)]] is formed all-over the entire surface and is made of solid material.

10. The portioning machine as claimed in any one of claims 1 to 9 claim 1, wherein the slide element [[(222)]] is withdrawn from the magazine turret attachment (100) when in the release position.

11. The portioning machine as claimed in any one of claims 1 to 10 claim 1, wherein the slide element [[(222)]] is arranged in such a manner when it is in the release position and/or the slide element [[(222)]] is realised in such a manner that the compressed, strand-like product may pass by the slide element [[(222)]] when the latter is in the release position.

12. A method of controlling a portioning machine [[(P)]] for dividing a preferably strand-like product into individual portions, wherein the portioning machine [[(1)]] includes a magazine turret attachment [[(100)]] for receiving the strand-like product, a pressing unit [[(200)]] for pressure-compacting the strand-like product at least in its longitudinal direction, and a portioning and cutting device [[(300)]] for portioning and separating individual portions from the strand-like product, said method including the steps of:
inserting a strand-like product into at least one reception chute [[(150)]] of the magazine turret attachment [[(100)]];
pressure-compacting the strand-like product at least in its longitudinal direction by displacing a pressure ram into the reception chute [[(150)]] in the direction of a slide element [[(222)]] of the pressing unit [[(200)]] located in the closure position;
moving the slide element [[(222)]] to a release position after the pressure-compacting operation has been accomplished;
displacing the pressure-compacted, strand-like product in the direction of the portioning and cutting device [[(300)]] by means of the pressure ram of the pressing unit [[(200)]];
separating individual portions from the pressure-compacted, strand-like product by the portioning and cutting device [[(300)]].

13. The method as claimed in claim 12, wherein the reception chute [[(150)]] for inserting the strand-like product is placed in a reception position.

14. The method as claimed in claim 13, wherein the reception chute [[(150)]] is moved to a cutting position, once a strand-like product has been inserted therein.

15. The method as claimed in claim 12, further including the step of: portionwise advancing the pressure-compacted, strand-like product is by the pressure ram [[(210)]], once the pressure-compacting operation has been accomplished.

16. The method as claimed in claim 12, wherein the portioning machine [[(P)]] includes a transporting device [[(400)]] for removing the individual portions that have been separated from the strand-like product;
further including the step of: controlled driving of the transporting unit [[(400)]] for creating individual portions or groups of individual portions.
